(19) United States
(12) Patent Application Publication
(10) Pub. No.: US 2003/0004806 A1
(43) Pub. Date: Jan. 2, 2003

(54) Business method of auctioning advertising

(76) Inventor: Jeffrey J. Vaitekunas, West Chester, OH (US)

Correspondence Address: JEFFREY J. VAITEKUNAS, 6081 INDIAN TRAIL, WEST CHESTER, OH, 45069, US

(21) Appl. No.: 10/175,167

(22) Filed: Jun. 19, 2002

Related U.S. Application Data
(60) Provisional application No. 60/302,093, filed on Jun. 29, 2001.
(60) Provisional application No. 60/302,118, filed on Jun. 29, 2001.
(60) Provisional application No. 60/302,119, filed on Jun. 29, 2001.
(60) Provisional application No. 60/329,808, filed on Oct. 16, 2001.

(51) Int. Cl. G06F 17/60

(52) U.S. Cl. 705/14; 705/26

(57) ABSTRACT

A business method for billboard advertising discloses auctioning display-time on billboards capable of dynamic-content display. The method provides the auctioning of display-time on at least one content-display unit. An auction may be based on a time period, a type identifier, group, content-display unit location, a hierarchy, or other desirable segmentation. An advertising billboard device for use with the present invention comprises a display controller adapted to receive, store, and display dynamic-content from the server. At least one content-display unit is in communication with the display controller, wherein the content-display unit visually displays the information from the dynamic-content. The advertising billboard display controller may also comprise a timing means, the display controller altering the visual display of the content-display unit as a function of a signal from the timing means. The display controller may be adapted to receive, store, and display dynamic-content from one or a plurality of servers, wherein the display controller comprises a hierarchical control scheme, the hierarchical control scheme adapted to select dynamic-content from one server of the plurality of servers for display on the content-display unit. The advertising billboard device may also comprise a plurality of display controllers in communication with a plurality of content-display unit devices, each display controller from the plurality of display controllers having a type identifier, wherein each of the display controllers selects dynamic-content for display on its content-display unit as a function of the type identifier.

This application is related to, and claims the benefit of, U.S. provisional applications Serial No. 60/302,093; Serial No. 60/302,118; and Serial No. 60/302,119, all filed Jun. 29, 2001, and U.S. provisional application Serial No. 60/329,808 filed Oct. 16, 2001, which are hereby incorporated herein by reference. This application is also related to U.S. applications Serial No. [Agent Docket No. JJV006]; Serial No. [Agent Docket No. JJV007]; and Serial No. [Agent Docket No. JJV008], all filed Jun. 19, 2002, which are hereby incorporated herein by reference.

### FIELD OF THE INVENTION

The present invention relates, in general, to a business method of auctioning advertising and, more particularly, to advertising business methods for auctioning display-time for billboards capable of dynamic-content display.

### BACKGROUND OF THE INVENTION

Billboards are used to display various messages typically consisting of a combination of text and graphics. Traditionally, the message has been provided by way of fixed sheets that are pasted to a backing. This traditional approach suffers from the inability to quickly change the displayed message, because it requires the use of a crew to change the message. Electronic billboards provide the advantage in that it is easier to change the displayed message. Electronic billboards include the dot matrix type utilizing many individual bulbs. Within stadiums, arenas and auditoriums there presently are electronic dot matrix display devices used for instant replays, advertising and customer information. While these electronic billboards are easily changed, they are difficult to manage and often require significant support resources to coordinate billboard content.

Loban et al. disclose a video billboard including a remote computer control with radio communications to the billboard display in U.S. Pat. No. 5,612,741 ('741). The '741 patent discloses that display information is communicated from a master computer to a receiver in the billboard housing which, in turn, controls the light valve display of the '741 invention. Commands may also be communicated via shared or dedicated landlines. The '741 billboard is capable of providing complex video graphics with high contrast ratios. It can provide message changes on command through landline, cellular phone, satellite relay or other wireless communication links. Within the commercial advertising billboard industry it will allow the use of computer video control to change graphics easily and quickly, as desired. Advertisements, public service announcements or traffic conditions can be displayed in near real time from remote locations since images can be downloaded via the communication links and displayed at pre-programmed time slots, if desired.

Gofman et al. disclose a system and method for serving local and global media content in PCT publication WO 00/52935 ('52935). The '52935 publication discloses a system and method for combining broadcast media content with additional content at a local site according to at least one locally determined characteristic of the audience to which the combined content is served. The '52935 publication discloses a template containing information concerning the type of data objects to be displayed, their size and location on the display, as well as the timing of display and transitions to the display, such that the template describes how to process and display the data.

New display materials are being developed that have the potential to expand advertising billboard technology, such as, for example, GYRICON a trade name of Xerox Corporation, Palo Alto Research Center, Palo Alto Calif. These new materials have the potential to expand the capabilities of billboard displays. Another new material for displays is E-INK, a trade name of E Ink Corporation 733 Concord Avenue, Cambridge, Mass. GYRICON technology is disclosed, for example, in U.S. Pat. No. 4,126,854. E-INK technology is disclosed, for example, in U.S. Pat. No. 6,120,588.

The proliferation of on-line or internet-based capabilities is re-defining how business is done. U.S. Pat. No. 5,960,411 issued to Peri Hartmen et al. discloses a method and system for placing a purchase order via a communications network, such as the internet. The order is placed by a purchaser at a client system and received by a server system. The server system receives purchaser information including identification of the purchaser, payment information, and shipment information from the client system. The server system then assigns a client identifier to the client system and associates the assigned client identifier with the received purchaser information. The server system sends to the client system the assigned client identifier and an HTML document identifying the item and including an order button. The client system receives and stores the assigned client identifier and receives and displays the HTML document. In response to the selection of the order button, the client system sends to the server system a request to purchase the identified item. The server system receives the request and combines the purchaser information associated with the client identifier of the client system to generate an order to purchase the item in accordance with the billing and shipment information whereby the purchaser effects the ordering of the product by selection of the order button. U.S. Pat. No. 5,960,411 is hereby incorporated herein by reference.

U.S. Pat. No. 6,058,417 ('417) titled Information Presentation and Management in an On-line Trading Environment, issued to Martin L. Hess et al. discloses the auctioning of items on the internet. The '417 patent describes person-to-person commerce over the Internet facilitated by providing prospective buyers the ability to quickly preview items for sale. Images are harvested from a plurality of sites based upon user-supplied information. The user-supplied information includes descriptions of items for sale and locations from which images that are to be associated with the items can be retrieved. Thumbnail images are created corresponding to the harvested images and are aggregated onto a web page for presentation at a remote site. According to another aspect of the '417 patent disclosure, a user may submit a query to preview items for sale. After receiving the query, thumbnail images corresponding to items that satisfy the user query are displayed, each of the thumbnail images previously having been created based upon a user-specified image. U.S. Pat. No. 6,058,417 is hereby incorporated herein by reference.

Although significant improvements are expanding the capabilities of billboard displays, as the capabilities expand the effort necessary to control the displays is expanding concurrently. It would therefore be advantageous to provide an improved method of billboard advertising that reduces the effort necessary to manage dynamic billboard displays. It would further be advantageous to provide an advertising device that easily controls multiple combinations of content-display units. It would also be advantageous to provide easily manageable dynamic-content display. It would further be advantageous to provide a system capable of time shared display output from a heirarchical control structure.

### SUMMARY OF THE INVENTION

A business method for billboard advertising is disclosed. A business method according to the present invention provides the auctioning of display-time on at least one content-display unit. An auction may be based on a time period, a type identifier, group, content-display unit location, a hierarchy, or other desirable segmentation. An advertising billboard device for use with the present invention comprises a display controller adapted to receive, store, and display dynamic-content from the server. At least one content-display unit is in communication with the display controller, wherein the content-display unit visually displays the information from the dynamic-content. The advertising billboard display controller may also comprise a timing means, the display controller altering the visual display of the content-display unit as a function of a signal from the timing means. The display controller may be adapted to receive, store, and display dynamic-content from one or a plurality of servers, wherein the display controller comprises a hierarchical control scheme, the hierarchical control scheme adapted to select dynamic-content from one server of the plurality of servers for display on the content-display unit. The advertising billboard device may also comprise a plurality of display controllers in communication with a plurality of content-display unit devices, each display controller from the plurality of display controllers having a type identifier, wherein each of the display controllers selects dynamic-content for display on its content-display unit as a function of the type identifier. An advertising system in accordance with the present invention may also include a camera located in viewing proximity to the content display unit, capable of providing an image of the content display unit.

A business method for billboard advertising in accordance with the present invention includes the following steps:

A) providing an advertising system, wherein the advertising system comprises:

at least one display controller, wherein the display controller is adapted to receive, store, and display dynamic-content; and

at least one content-display unit in communication with the display controller, wherein the content-display unit visually displays the information from the dynamic-content;

B) receiving advertising information from an advertiser;

C) auctioning display-time on the content-display unit; and

D) displaying the advertising information on the content-display unit.

A business method in accordance with the present invention may also include one or more of the steps of:

E) In step D, the displaying step may be divided into a plurality of time segments, allowing the step of: displaying a first advertisement during a first time segment and displaying a second advertisement during a second time segment.

F) segmenting a plurality of content-display units into a plurality of groups, each group from the plurality of groups identified with a characteristic;

G) selecting a group from the plurality of groups to display dynamic-content on the plurality of content-display units having the group characteristic.

Further, one or more servers may be provided, each in communication with one or more content-display units. A plurality of servers may be provided, and the business method may further comprise:

H) auctioning a hierarchy, the hierarchy defining a prioritization of the plurality of servers to at least one of the display controllers such that the display controller selects one server from the plurality of servers.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is a block diagram of an advertising billboard system in accordance with the present invention;

FIG. 2 is a block diagram of an advertising billboard system including a plurality of content-display units in accordance with the present invention;

FIG. 3 is a block diagram of an advertising billboard device in accordance with the present invention;

FIG. 4 is a block diagram of an advertising billboard system with a hierarchical control in accordance with the present invention;

FIG. 5 is a flow chart illustrating a business method of billboard advertising in accordance with the present invention;

FIG. 6 illustrates a business method in accordance with the present invention where an advertiser selects content-display units for their advertisement via the Internet; and

FIG. 7 illustrates a business method in accordance with the present invention where an advertiser bids on display-time, groups of content-display units, hierarchies, and characteristics for content-display units for their advertisement via the internet.

### DETAILED DESCRIPTION OF THE INVENTION

The present invention relates, in general, to a business method for billboard advertising and, more particularly, to advertising business methods for auctioning display-time on billboards capable of dynamic-content display.

Content-display units are herein defined to include any visual display or portion of display capable of displaying information from dynamic-content such as, for example, video billboards, GYRICON, E-lnk, computer monitors, shopping mall kiosks, stadium displays, personal digital assistants, movie-theater screens, video projectors, and cellular phone displays. Content display units are divided into two types, active content-display units and passive content-display units. Active content-display units are displays that only display dynamic-content when they are actively being addressed or written on, such as, for example, computer monitors, movie-theater screens, and L.E.D. displays. Passive content-display units are displays that, when not being actively written to or addressed, retain a viewable image such as, for example, GYRICON and E-INK.

A suitable material for a passive content-display media would be, for example, SMARTPAPER (Trademark of Gyricon Inc. Palo Alto, Calif.) technology using an array of tiny (100 micron diameter or smaller) solid beads with one hemisphere of each bead one color (e.g. white) and the other a different color (e.g. black). These beads are embedded in a flexible plastic sheet in small cavities surrounded by a liquid. Each bead carries an electrical charge. When an external electric field is applied the bead rotates or gyrates. Adhesive forces between each bead and cavity wall require an electrical threshold be exceeded before it will rotate. This makes an image electrically “printed” onto the material stable and unchanging until “erased” by another transmission. Electrical signals can be applied to the SMARTPAPER sheets through fixed surface electrodes or a moving stylus. A networked programmable sign will run for up to 2 years on 3 AA batteries, with the power almost completely used by the communications and processing systems. SMARTPAPER itself requires just a capacitance or voltage (about 100 volts), not a power current. Unlike other types of electronic displays, SMARTPAPER has a wide viewing angle identical to traditional printed signs. This allows SMARTPAPER to be viewed like paper, from all angles and without added backlighting. Images can currently be displayed on SMARTPAPER with resolution over 100 dpi. Applying electrical fields to the display surface changes the image on SMARTPAPER. For purposes herein, GYRICON and SMARTPAPER are synonymous.

Dynamic-content is herein defined as information or data to be visually displayed that is updateable or changeable by electronic control such as, for example, pixel data for an image, analog beam modulation information for a cathode ray tube (CRT), streaming video, and ASCII or other codes.

Display-time is herein defined as the actual display of dynamic-content on a content-display unit.

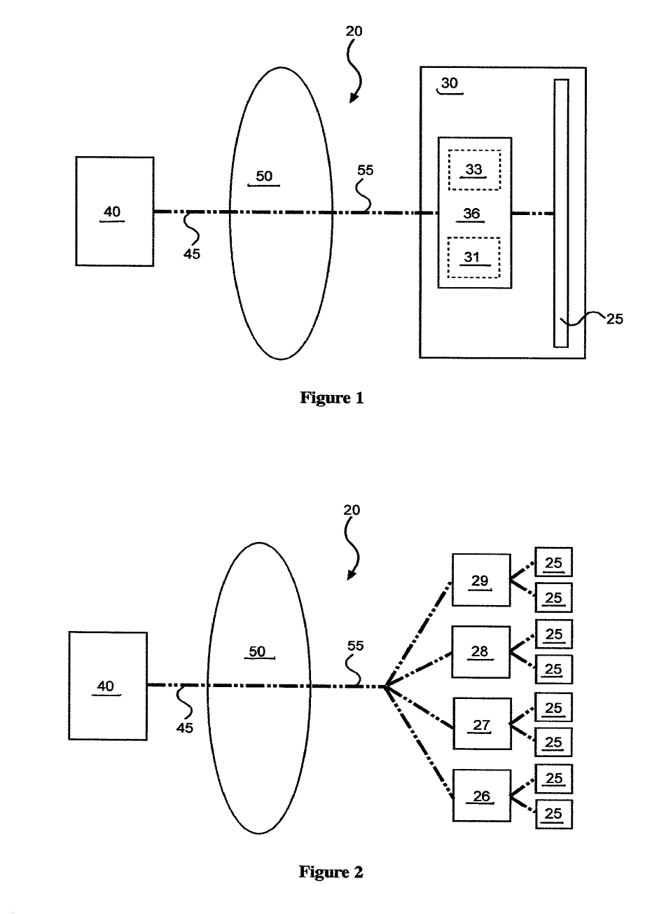

FIG. 1 is a block diagram of an advertising billboard system 20 in accordance with the present invention. Advertising billboard system 20 comprises a server 40 and a display controller 30 adapted to receive, store, and display a dynamic-content 70 from the server 40. Display controller 30 includes at least one content-display unit 25, a receiver 36, storage means 33, and may include a timing means 31. Dynamic-content 70 is transmitted from server 40 on a transmission path 45, through transmission media 50, and on receiving path 55 to display controller 30. Transmission path 45, transmission media 50, and receiving path 55 may be any one or combination of data transfer such as, for example, telephone wire, internet link, radio communication, cellular telephony, microwave link, local area network, and satellite broadcast. Receiver 36 receives the dynamic-content 70 where it is either stored in storage means 33, or displayed on content-display unit 25. Storage means 33 may be, for example, dynamic RAM in a computer, videotape, display memory, and computer hard disk.

The content-display unit 25 visually displays the information from the dynamic-content 70. The timing means 31 may be, for example, a clock, a Global Positioning System (GPS), timing trigger, or other means of detecting a timing event. The display controller 30 alters the visual display of the content-display unit 25 as a function of the time or position from the timing means 31. For example, if content-display unit 25 is located near a commuter highway visible to commuters, it may be desirable to display a first message on content-display unit 25 during commuter rush hours, and to display a second different message on content-display unit 25 at other times.

Content-display unit 25 may be located, for example, on the side of a semi-trailer travelling over the road within a city. It may be desirable to display a first message whenever the semi-trailer is within a defined area, and a second message whenever the semi-trailer is outside of a defined area. It is contemplated that, for example, within the boundaries of an acceptable travelling range a first message could indicate trailer contents, and outside the acceptable travelling range a second message could indicate that the trailer should be stopped. As a second example, whenever a trailer having a content-display unit 25 is within a defined distance from “JOE's”, it may be desirable to display “EAT at JOE's” on display unit 25.

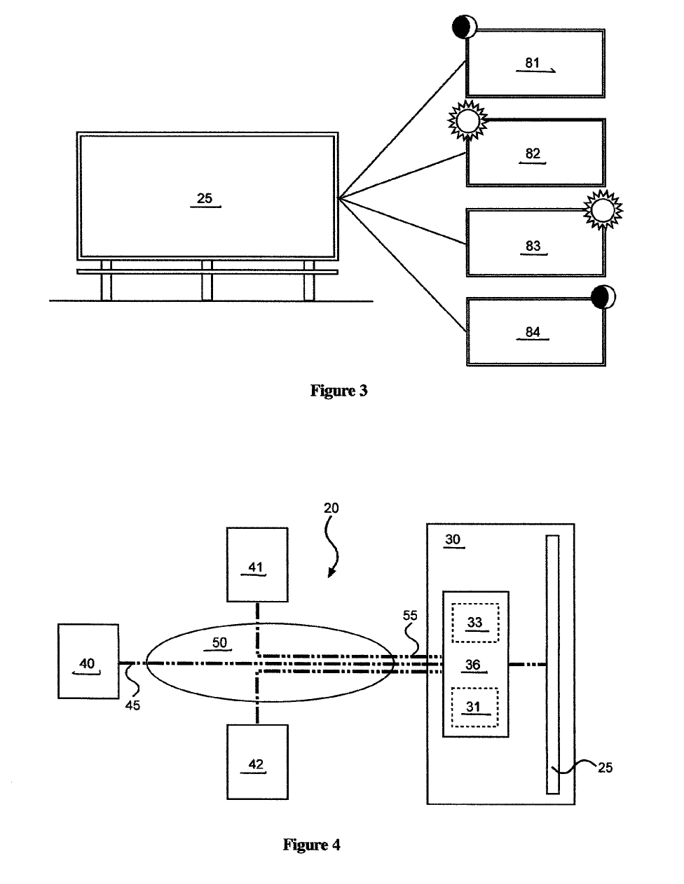

FIG. 2 is a block diagram of advertising billboard system 20 including a plurality of content-display units 25 in accordance with the present invention. The advertising billboard system 20 may also comprise a plurality of display controllers 26, 27, 28, 29 in communication with a plurality of content-display units 25, each one from the plurality of display controllers 26, 27, 28, 29 having a type identifier, wherein each of the display controllers 26, 27, 28, 29 selects dynamic-content 70 for display on its content-display unit 25 as a function of its type identifier. For example, display controller 26 may have a type identifier of highway billboard, display controller 27 may have a type identifier of shopping mall kiosk, display controller 28 may have a type identifier of computer monitors on a local area network, and display controller 29 may have a type identifier of a semi-trailer driving past “JOE's Diner”. FIG. 3 is a block diagram of a content-display unit 25 in accordance with the present invention. Content-display unit 25 may display dynamic-content 70 that changes over time such as, for example, video, image morphing, sequential messages, or discrete time periods of static image. FIG. 3 illustrates an example of discrete time periods of static image. An image 81 may be displayed on content-display unit 25 during the overnight period of a day, an image 82 may be displayed on content-display unit 25 during the morning drive-time period of a day, an image 83 may be displayed on content-display unit 25 during the afternoon drive-time period of a day, and an image 84 may be displayed on content-display unit 25 during the evening period of a day,

FIG. 4 is a block diagram of an advertising billboard system 20 with a hierarchical control in accordance with the present invention. The display controller 30 may be adapted to receive, store, and display dynamic-content 70 from a plurality of servers illustrated in FIG. 4 as server 40, a second server 41, and a third server 42. Display controller 30 comprises a hierarchical control scheme, the hierarchical control scheme adapted to select dynamic-content 70 from one server of the plurality of servers for display on the content-display unit 25. The hierarchical control scheme may be prioritized or heuristic. For example, server 40 may be a national host computer at a highest priority, second server 41 may be a regional host computer at a middle priority, and third server 42 may be a local host computer at a low priority. Since any or all servers may be transmitting dynamic-content 70 at any time or simultaneously, the hierarchical control scheme will select which dynamic-content 70 is displayed on content-display unit 25 at any time.

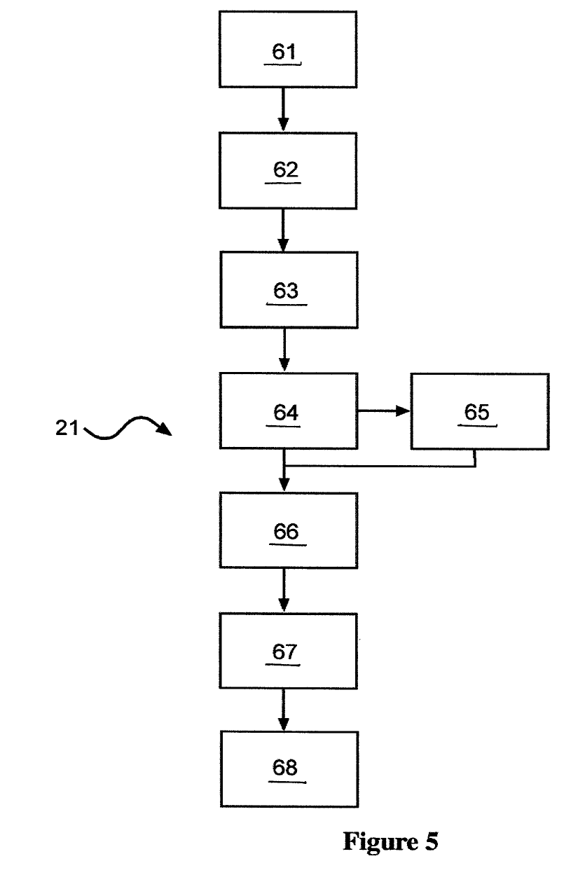

FIG. 5 is a flow chart illustrating a business method 21 of billboard advertising in accordance with the present invention. The business method 21 for billboard advertising illustrated in FIG. 5 includes the following steps:

A) providing an advertising system, wherein the advertising system comprises:

at least one display controller, wherein the display controller is adapted to receive, store, and display dynamic-content; and

at least one content-display unit in communication with the display controller, wherein the content-display unit visually displays the information from the dynamic-content;(illustrated as step 61)

B) receiving advertising information from an advertiser;(illustrated as step 62)

C) auctioning display-time on the content-display unit;(illustrated as step 63)

D) displaying the advertising information on the content-display unit.(illustrated as step 64)

In step D, the displaying step may be divided into a plurality of time segments, allowing the step of:

E) displaying a first advertisement during a first time segment and displaying a second advertisement during a second time segment. (illustrated as step 65)

F) segmenting a plurality of content-display units into a plurality of groups, each group from the plurality of groups identified with a characteristic;(illustrated as step 66)

G) selecting a group from the plurality of groups to display dynamic-content on the plurality of content-display units having the group characteristic.(illustrated as step 67)

Further, one or more servers may be provided, each in communication with one or more content-display units. A plurality of servers may be provided, and the business method may further comprise:

H) selecting a hierarchy, the hierarchy defining a prioritization of the plurality of servers to at least one of the display controllers such that the display controller selects one server from the plurality of servers.(illustrated as step 68)

Illustrations of method steps, such as, for example, the steps illustrated in FIG. 5, show steps sequentially and in a particular order. There is no need to perform the steps in the order illustrated. Deviating from the illustrated order for some or all of the steps is contemplated by the inventor, and does not depart from the scope of the present invention.

On-line auctioning of items is a convenient way for consumers to find and acquire desirable things. The present invention provides a new way of doing business in marketing and advertising. A business method of auctioning billboard advertising according to the present invention brings marketing and advertising to a broader range of advertisers. Any individual, organization, corporation, small business, or government agency is able to access any billboard with its message in a simple, easily managed process using the present invention. Alternately, billboard management firms or corporations can more easily and efficiently manage their advertising capabilities more efficiently utilizing the present invention.

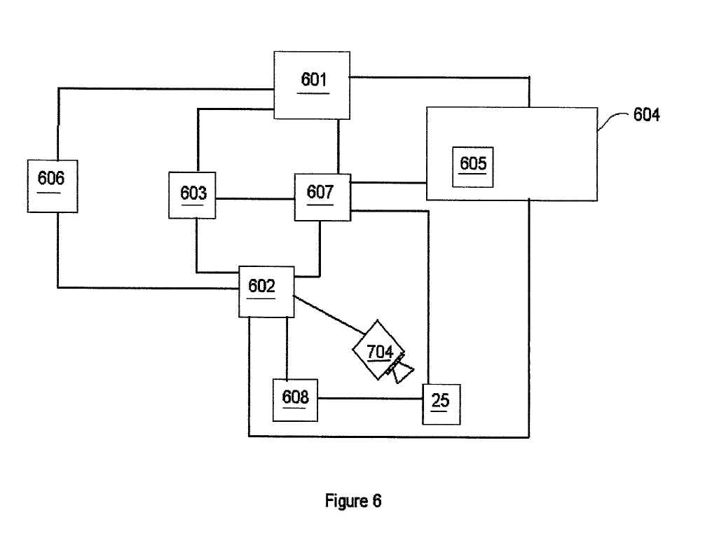

FIG. 6 illustrates a business method in accordance with the present invention where an advertiser selects content-display units 25 for their advertisement via the Internet. An order 607 to display dynamic-content on one or more content-display units 25 is placed by a purchaser at a client system 601 and received by a server system 602. The server system 602 receives purchaser information including identification of the purchaser, payment information, and dynamic-content location information from the client system 601. The server system then assigns a client identifier 603 to the client system 601 and associates the assigned client identifier 603 with the received purchaser information. The server system 602 sends to the client system 601 the assigned client identifier 603 and an HTML document 604 identifying the content-display units 25 and including an order button 605. The client system 601 receives and stores the assigned client identifier 603 and receives and displays the HTML document 604. In response to the selection of the order button 605, the client system 601 sends to the server system 602 a request 606 to purchase display-time on the content-display units 25. The server system 602 receives the request 606 and combines the purchaser information associated with the client identifier 603 of the client system 601 to generate the order 607 to display the dynamic-content on the content-display units 25 in accordance with the billing information, whereby the purchaser orders the display-time by selection of the order button 605. Server system 602 sends dynamic content 608 to content-display unit 25 for display-time according to order 607. Content-display units 25 such as, for example, a roadside billboard, may have a camera 704 accessible via the Internet for viewing the billboard and its surroundings, to verify display-time or for service and quality control purposes.

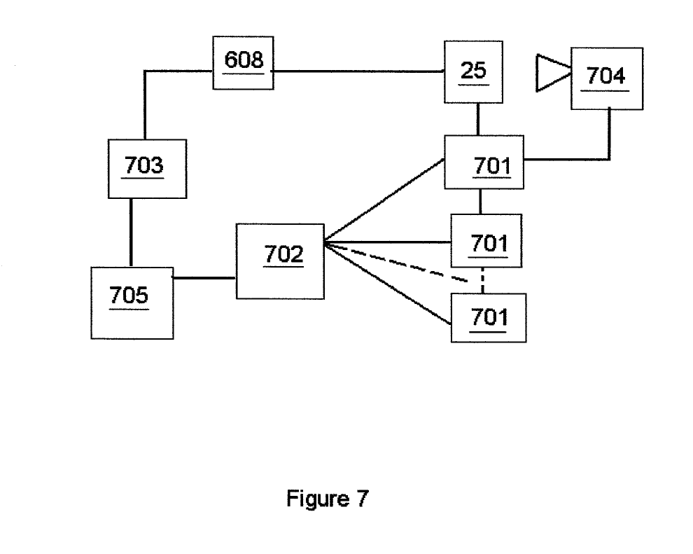

FIG. 7 illustrates a business method in accordance with the present invention where an advertiser bids on display-time, groups of content-display units 25, hierarchies, and characteristics for content-display units 25 for their advertisement via an Internet based auction. Providing prospective advertisers the ability to quickly preview content-display units available for advertising facilitates advertising commerce over the Internet. Images 701 are harvested from a plurality of sites based upon advertising system information. The advertising system information includes descriptions of content-display units 25 available and locations from which images 701 that are to be associated with the content-display units 25 can be retrieved. Thumbnail images are created corresponding to the harvested images 701 and are aggregated onto a web page 702 for presentation at a remote site. A user may submit a query 703 to preview content-display units 25 available. After receiving the query 703, thumbnail images and textual descriptions corresponding to items that satisfy the user query 703 are displayed. Content-display units 25 such as, for example, a roadside billboard, may have a camera 704 accessible via the Internet for viewing the billboard and its surroundings, as a basis for thumbnail images. The user may then place a bid 705 describing the maximum amount the user is willing to pay for display-time on a selected set of content-display units 25. Bid 705 may be placed similarly to the process illustrated in FIG. 6, as described above. If the user is the high bidder, then the users dynamic-content is displayed on the selected content-display units 25 during the selected display-time.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features. In addition, it should be understood that every structure described above has a function and such structure can be referred to as a means for performing that function.

While preferred embodiments of the present invention have been shown and described herein, it will be obvious to those skilled in the art that such embodiments are provided by way of example only. Numerous variations, changes, and substitutions will be apparent to those skilled in the art without departing from the invention. Accordingly, it is intended that the invention be limited only by the spirit and scope of the appended claims.

What is claimed is:

1. A business method for billboard advertising comprising the steps of:
A) providing a content-display unit;
B) providing a display controller, wherein said display controller is adapted to receive, store, and provide dynamic-content for said content-display unit;
C) receiving advertising information from an advertiser; and
D) auctioning display-time on said content-display unit.

2. The business method of claim 1 further comprising the steps of:
E) providing a plurality of content-display units, each having a display is controller;
F) identifying each content-display unit of said plurality of content-display units with at least one characteristic; and
G) displaying said advertising on each of said plurality of content-display units having one of said at least one characteristic.

3. The business method of claim 2 further comprising the steps of:
H) providing a clock indicating a time; and
J) changing the dynamic-content-displayed on at least one said content-display units from a first dynamic-content to a second dynamic-content at a first time.

4. The business method of claim 2 further comprising the steps of:
K) providing a plurality of servers; and
L) providing a hierarchy to at least one said display controller, said hierarchy used to select one server from said plurality of servers for dynamic-content to display by said display controller.

5. The business method of claim 2 wherein said content-display unit is located on a moving vehicle.

6. The business method of claim 5 wherein said vehicle is a semi-trailer.

7. The business method of claim 2 wherein said characteristic is a unique location.

8. The business method of claim 2 wherein said characteristic is an area.

9. The business method of claim 3 wherein said characteristic is a unique location.

10. The business method of claim 3 wherein said characteristic is an area.

11. A business method for billboard advertising comprising the steps of:
A) providing an advertising system, wherein said advertising system comprises:
at least one server;
at least one display controller, wherein said at least one display controller is adapted to receive, store, and display dynamic-content from said at least one server; and
at least one content-display unit in communication with said at least one display controller, wherein said at least one content-display unit visually displays the information from said dynamic-content;
B) receiving advertising information from an advertiser;
C) communicating said advertising information as dynamic-content from said at least one server to said at least one display controller; and
D) auctioning display-time on at least one content-display unit.

12. The business method of claim 11 further comprising the step of:
E) segmenting a plurality of content-display units into a plurality of groups, each group from said plurality of groups identified with a characteristic.

13. The business method of claim 12 further comprising the step of:
F) selecting a group from said plurality of groups to display dynamic-content on said plurality of content-display units having said group characteristic.

14. The business method of claim 12 wherein in step D, said displaying step is divided into a plurality of time segments, wherein a first advertisement is displayed during a first time segment and a second advertisement is displayed during a second time segment.

15. The business method of claim 13 wherein in step D, said displaying step is divided into a plurality of time segments, wherein a first advertisement is displayed during a first time segment and a second advertisement is displayed during a second time segment.

16. The business method of claim 13 wherein in step A, a plurality of servers are provided, said business method further comprising the step of:
G) selecting a hierarchy, said hierarchy defining a prioritization of said plurality of servers to at least one of said display controllers such that said at least one display controller selects one server from said plurality of servers.

17. The business method of claim 14 wherein in step A, a plurality of servers are provided, said business method further comprising the step of:
G) selecting a hierarchy, said hierarchy defining a prioritization of said plurality of servers to at least one of said display controllers such that said at least one display controller selects one server from said plurality of servers.

18. The business method of claim 15 wherein in step A, a plurality of servers are provided, said business method further comprising the step of:
G) selecting a hierarchy, said hierarchy defining a prioritization of said plurality of servers to at least one of said display controllers such that said at least one display controller selects one server from said plurality of servers.

19. The business method of claim 15, wherein said at least one content-display unit is a passive content-display unit.

20. The business method of claim 19 wherein said passive content-display unit comprises GYRICON.

21. The business method of claim 19 wherein said passive content-display unit comprises E-INK.

22. A business method for billboard advertising comprising the steps of:
A) providing a content-display unit;
B) providing a display controller, wherein said display controller is adapted to receive dynamic-content for said content-display unit;
C) receiving dynamic-content; and
D) auctioning display-time on said content-display unit.
